(19) United States
(12) Patent Application Publication
(10) Pub. No.: US 2017/0015012 A1
(43) Pub. Date: Jan. 19, 2017

(54) Device for Separating Containers Connected to Container Groups and Corresponding Method

(71) Applicant: Robert Bosch GmbH, Stuttgart (DE)

(72) Inventor: Cyrille Fuellemann, Schaffhausen (CH)

(73) Assignee: Robert Bosch GmbH, Stuttgart (DE)

(21) Appl. No.: 15/124,757

(22) PCT Filed: Feb. 18, 2015
(86) PCT No.: PCT/EP2015/053436

§ 371 Date: Sep. 9, 2016

(30) Foreign Application Priority Data
Mar. 11, 2014 (DE) 10 2014 204 384.0

(51) Int. Cl. B26D 1/00; B65B 61/06; B26D 7/06

(52) U.S. Cl. CPC B26D 1/0006; B26D 7/0625; B65B 61/06; B26D 2001/0066

(57) ABSTRACT

A device for separating containers, particularly ampoules, connected to container groups includes a separating unit and a positioning unit. The separating unit is configured to separate at least one container of a container group that is in a foremost position along an advancing direction from at least one further container in the container group located upstream of the at least one container along the advancing direction via a separating process. The separating process acts in a separating region of the separating unit in a direction crosswise to the advancing direction. The positioning unit is configured to interlockingly position the at least one further container of the container group during the separating process.

### PRIOR ART

A device for severing containers that are connected in container groups, having a severing unit that is provided for severing at least one container, which is foremost in a feed direction, of the container group from at least one further container of the container group along a severing region, in a severing procedure transverse to the feed direction, has already been proposed.

### DISCLOSURE OF THE INVENTION

The invention takes as its starting point a device for severing containers, in particular vials, that are connected in container groups, having a severing unit that is provided for severing at least one container, which is foremost in a feed direction, of the container group from at least one further container of the container group along a severing region, in a severing procedure transverse to the feed direction.

There is proposed a positioning unit that is provided for form-fittingly positioning during the severing procedure the at least one container, which is arranged upstream of the severing region as seen in the feed direction, of the container group. In this context, the term “containers that are connected in container groups” should be understood as preferably container groups that are made by a so-called blow fill seal method. In this method, a container group, for example comprising five to seven containers, is formed, filled and sealed from a plastics material, in particular polypropylene, in a blow fill seal machine. Also known are container groups made from other plastics, and in particular container groups having a multiple-layer construction of different plastics materials. The result is container groups in which the individual containers are connected lying next to one another in a container group direction transverse to their principal extent, to form a card-shaped container group. The containers have a container part that is filled with a filling material. At one end, the container part is delimited by a head part at which the container can be opened by breaking off or twisting off the head part. At an opposite end, the container part is delimited by a foot part. The head part and foot part are typically constructed to be flat at their ends and form guide surfaces. These guide surfaces make it easier to position and guide the container group in devices. Also known are container groups in which a plurality of container parts is arranged in the direction of principal extent. In particular, two container parts may be arranged in the direction of principal extent, wherein the head parts are arranged at opposite ends on the container parts. In this arrangement there are no foot parts. Consequently, such container parts are understood as belonging to a container. Those skilled in the art will appropriately apply the described invention, in the case of container groups of this kind, by using them to sever containers that are arranged adjacent to one another in the container group direction. Between adjacent containers, typically parallel to the principal extent of the containers, there are arranged severing points, which are formed by weakened lines and/or notches in connection webs that connect the containers. These severing points make it easier to sever individual containers from the container group. Container groups of this kind are known to those skilled in the art. In this context, the term “severing region” should be understood in particular to mean a region of the device in which the containers are severed along their connection web. Preferably, by means of the device, first the severing point of the connection web is moved into the severing region, after which the connection web is severed along the severing region and hence at its severing point. The device may be provided for severing a plurality of containers, preferably a single container, from the container group in one severing procedure.

In this context, the term “feed direction” should in particular be understood to mean a direction in which the container group is transported onward between severing procedures in order to transport the next container to be severed to the severing unit. The feed direction may in particular be at least substantially parallel to the direction of the container group. In this context, the term “at least substantially” should be understood to mean a deviation of less than 10°. In this context, the term “form-fittingly position” should in particular be understood to mean that the container is moved, at least in the feed direction, into a target position that is advantageous for the severing unit and/or held therein by form fit. The form fit may be with the container and/or the container part of the container. Preferably, the positioning unit form-fittingly positions by performing at least two translational movements and at least two rotational movements. In particular, during positioning, the positioning unit may have at least three linear contacts with the container about a container longitudinal axis in the direction of its principal extent. In this context, the term “linear contact” should in particular be understood to mean a contact along a contact line or at at least two contact points that are arranged on a line, wherein the contact along the contact line may be broken a plurality of times.

Preferably, the container may be divided about the container longitudinal axis into three peripheral segments, each of 120°, that each have a linear contact with the positioning unit during positioning. The severing unit may, particularly advantageously, sever along the severing region one or more containers from the container group having the container that has been positioned by the positioning unit. In particular, displacement of the container group during severing may be prevented. The severing unit can sever containers particularly rapidly. Forces that act on the container group during severing may be taken up by the positioning unit. Damage to the container parts of the containers by the severing unit can be avoided.

Particularly advantageously, the positioning unit is provided for form-fittingly positioning during the severing procedure a container of the container group that adjoins the severing region in the opposite direction to the feed direction. The positioning unit can conduct away forces that are produced during the severing procedure at a particularly small distance from the severing region. Excessive deformation and/or damage to the container group can be avoided.

It is proposed that the positioning unit should have at least a first wedge, as seen in the feed direction, and a second wedge, as seen in the feed direction, that have at least partly opposite holding faces. In this context, the term “opposite” should in particular be understood to mean that surfaces normal to the holding faces each have a component that points in the direction of the respectively opposite holding face. The container to be positioned may advantageously be positioned between the two holding faces. Preferably, the first and the second wedge may be lowered in the direction of an upper side of the container group, in a closing direction perpendicular to the feed direction and/or container group direction and perpendicular to the principal extent of the containers in the direction of the container to be positioned. The first and the second wedge may position the container in that the holding faces are in contact with the container and exert a force on the container. Preferably, the container is supported, on an underside opposite the upper side, on a container support. The container support may be formed by a conveyor belt, a transport chain or another suitable support. In particular, a conveyor belt, a transport chain or a similar element may be adjoined in the feed direction by a dead plate, onto which the containers are pushed in the direction of transport and which forms a container support. The containers may preferably be supported on the container support by guide surfaces of their head and/or foot part and/or by their container part. The container may advantageously be positioned between the holding faces and the container support. The holding faces and container support are part of the positioning unit. The holding faces may be of planar construction. Preferably, the holding faces may be of concave construction. A contact face between the holding faces and the container may be made larger. The holding faces may also be of convex construction. Holding faces of convex construction may be particularly well suited to positioning an orientation of the container during rotation about its principal extent. Preferably, at least one wedge may have a wedge edge that is provided for form-fittingly positioning the container at its connection web, in particular at the severing point. A suitably shaped counter-piece of the container support may support the container against the wedge edge. Sagging of the container can be avoided. The container can in particular be positioned reliably. In a variant of the invention, the positioning unit may have a single wedge. The wedge may, by means of its wedge edge, clamp the container at the connection web thereof and, by means of its holding face, urge it away from the clamped connection web. The container may in this way be positioned in the feed direction by a single wedge. The second wedge may be dispensed with.

It is further proposed that the second wedge should have a first severing blade of the severing unit. The second wedge may advantageously position the last of the containers, upstream of the severing region as seen in the feed direction, of the container group and, cooperating with a further severing blade, sever the severing point for severing, in the severing region. A wedge edge of the second wedge may form a blade edge. Preferably, the second wedge and the first wedge may be mounted and/or driven together on a linear unit. The first and the second wedge may be moved together in the direction of the container group and position the latter, and the second wedge may, together with the further severing blade, sever the severing point in the severing region. Separate drives, components and mounting units for the wedges and the first severing blade may be dispensed with. Preferably, the first wedge is mounted on the linear unit to be resilient in the closing direction. It is possible to prevent the first wedge from exerting impermissibly great forces on the severing point. It is possible to prevent the container group from shearing off undesirably at the severing point that is positioned by the wedge edge of the first wedge. The linear unit can move the first and the second wedge together in the direction of the container group until the first wedge is in contact with the container group, at the connection web, by means of the wedge edge. The linear unit can now move the second wedge further in the closing direction until the holding face of the second wedge is in contact with the container part of the container and urges it in the direction of the first holding face, while the first wedge undergoes spring compression and remains at its position. Advantageously, it is possible to perform a first approximate positioning by the wedge edge of the first wedge and a subsequent fine positioning by the holding face of the second wedge. Advantageously, the holding face and/or the wedge edge of the second wedge can be set back, preferably by 0.1-5 mm, from the holding face and/or the wedge edge of the first wedge, in the opposite direction to the closing direction. Advantageously, it may be achieved that first the first and then the second wedge is brought into contact with the container. The container may first be positioned approximately and then finely in a particularly reliable manner. Positioning of the container may be particularly precise. As an alternative, a first severing blade may be constructed independently of the positioning unit and/or may be driven and/or mounted independently. The positioning unit and/or the wedges of the positioning unit may be arranged at a spacing from the severing region. Effects on the positioning unit from the severing procedure may be reduced.

Advantageously, an onward transport unit having at least one holder is proposed, wherein this holder forms a receiving region for receiving the containers that are each severed in a severing procedure. An upper side of the holder that has an opening in the receiving region may be inclined, preferably by 5°-15°, from the severing region in relation to the container support away from the underside of the container at a location at which the severed containers are received. The containers may be urged away from the severing region by the inclination and be received particularly securely by the receiving region. In this context, the term “onward transport unit” should in particular be understood to mean a unit that is provided for transporting severed containers away from the severing region. In particular, the onward transport unit may pass the severed containers on to a device that transports the containers to a next processing step, in particular a packaging process. Advantageously, at least one counter-holder is provided for securing the container once it has been taken up, to prevent its falling out of the receiving region. This may be done in that the counter-holder exerts forces on the container that are directed toward the receiving region. The onward transport unit can transport the severed containers onward particularly reliably. Preferably, an active control device is provided for moving the counter-holders. The receiving regions of the holders can be released from the counter-holder at the appropriate moment and/or containers that have been inserted in the receiving regions can be secured. Preferably, the active control device can have mechanical control slide links. The control device may be particularly rugged and reliable. The control device may have a drive unit that is provided for driving the control slide links. Movement of the counter-holders may be controlled particularly flexibly. Preferably, the counter-holders are provided for securing the containers once they have been taken up by the receiving regions and before they have been severed from the container group. The containers may be prevented from falling out of the receiving regions during severing.

Preferably, the onward transport unit is provided for transporting severed containers onward in an onward transport movement that, at least directly downstream of the severing procedure, has a principal motion component perpendicular to the feed direction and transverse to a principal extent of the severing region. In this context, the term “principal motion component” should in particular be understood to mean the largest motion component of a movement. The onward transport unit can transport severed containers onward in a direction transverse to the feed direction. It is also possible for the onward transport unit to transport the containers onward on an arcuate or preferably circular track. Preferably, a tangent to the track at the severing region may be perpendicular to the feed direction and the principal extent of the severing region. The holders may receive the severed container and transport it onward particularly well as a result of a movement perpendicular to the feed direction and transverse to the principal extent of the severing region. The severed containers may be transported away from the severing region particularly rapidly, so that feeding of the next container to be severed may be performed.

Advantageously, the at least one holder has a further severing blade of the severing unit. Preferably, the holder can have a blade edge that faces the severing region during the severing procedure and forms the further severing blade. This makes it possible to save on structural parts. The holder can cooperate with the first severing blade and sever the container and simultaneously receive the container.

It is proposed that the onward transport unit should have a plurality of holders in a cycle. In this context, the term “cycle” should in particular be understood to mean a closed track. The holders that form severing blades can be moved past the severing region in a continuous movement. Severing and onward transport of the containers can take place in a continuous process. The containers may be severed from the container groups and transported onward at a particularly high rate of throughput. The holders may be transported around the cycle by a chain or a conveyor belt. Preferably, the holders may be moved on a circular track. The holders may preferably be mounted on a transport wheel, which is mounted to turn about an axis, and be moved thereby in a circular cycle. The onward transport unit may receive a particularly large number of containers at the severing region and transport them onward. Preferably, the onward transport unit may discharge the containers to a further transport unit on a side of the transport wheel that is opposite the severing region. Preferably, the counter-holders are mounted to be movable on the transport wheel. Preferably, a cam disk is provided for suitably triggering control devices, in particular control followers, that are connected to the counter-holders. The control followers may be mounted on the transport wheel together with the counter-holders and the holders and may be driven in a cycle by the transport wheel. The cam disk may preferably be arranged centrally in relation to the transport wheel and be stationary in relation to a machine base of the device. In the region over which the control followers pass when the holders and counter-holders move past the severing region, the control cam has a deflected portion that displaces the counter-holder in the direction of the opening of the receiving region of the holders, and secures containers that are inserted in the receiving regions. The counter-holders may remain in this position and prevent containers from falling out of the receiving regions until the holders reach a discharge region, in which the containers are discharged to a next processing step. In this position, the control cam can once again have a deflected portion, which has the effect that the receiving regions can be opened and the containers discharged.

Preferably, the severing procedure is performed by two severing blades that are moved past one another in a shearing movement. The severing blades may act as shear blades. Preferably, the holders, which are moved in the severing region perpendicular to the feed direction and to the principal extent of the severing region, and which form further severing blades, may be moved past the first severing blade, which is formed by the second wedge, in a shearing movement, in order to sever the container that is to be severed from the container group, in the severing region of the severing unit at the severing point between the containers. The wedge edges of the severing blades, which form blade edges, may approximately touch as they come closest to one another during the severing procedure. The severing blades may sever the containers in the severing region by a cutting procedure. The cut edges that are produced may be particularly precise. Particularly preferably, the wedge edges of the severing blades are moved past one another while maintaining a severing clearance. The severing clearance may preferably be 0.1-0.3 mm. In this context, the term “severing clearance” should be understood as the spacing between the two wedge edges as they come closest to one another during the severing procedure. It is possible to avoid a collision of the wedge edges. The severing unit can be particularly reliable. Preferably, the wedge edge of at least one of the two severing blades may be inclined in relation to the closing direction. In particular, the wedge edge can form an angle of 75°-85° with the closing direction and/or the direction of the shearing movement. Preferably, the further wedge edge forms an angle of 90° with the direction of the shearing movement. Preferably, the second wedge has the inclined wedge edge. Preferably, the wedge edge of the holders form an angle of 90° with the shearing movement. The severing unit can sever the container in the severing region, at the severing point, by means of a punctiform shearing. Forces that occur during the severing can be small. Vibrations that are caused by the severing procedure can be reduced. The wedge edge can be treated with care. The severing unit can have a particularly long service life.

Further, a supply device for containers, having the device for severing containers that are connected in container groups, that has the described features is proposed. In particular, the supply device may be provided for a packaging machine for further packaging of the containers, in particular a tubular bagging machine. The supply device can have the said advantages.

Further, a method for severing container groups, having the device for severing containers that are connected in container groups, that has the described features is proposed. The method can have the said advantages. In particular, the method can be suitable for severing containers from container groups at a high rate of throughput and/or efficiency. The method can allow a continuous severing and onward transport process.

### DRAWING

Further advantages will become apparent from the description of the drawing below. The drawing illustrates an exemplary embodiment of the invention. The drawing, the description and the claims include numerous features in combination. Those skilled in the art will advantageously also consider the features individually and put them together into useful further combinations.

In the drawing:

FIG. 1 shows a schematic illustration of a device for severing containers that are connected in container groups,

FIG. 2 shows a schematic illustration of the container group, with the containers,

FIG. 3 shows a schematic illustration of possible variants of holding faces,

FIG. 4 shows a schematic illustration of a supply device having the device for severing containers that are connected in container groups,

FIG. 5 shows a detail from the device in FIG. 4,

FIG. 6 shows the device for severing containers that are connected in container groups, in operation, with containers, and

FIG. 7 shows a schematic illustration of a shearing movement of a first and a further severing blade in a plan view, perpendicular to a feed direction.

### DESCRIPTION OF THE EXEMPLARY EMBODIMENT

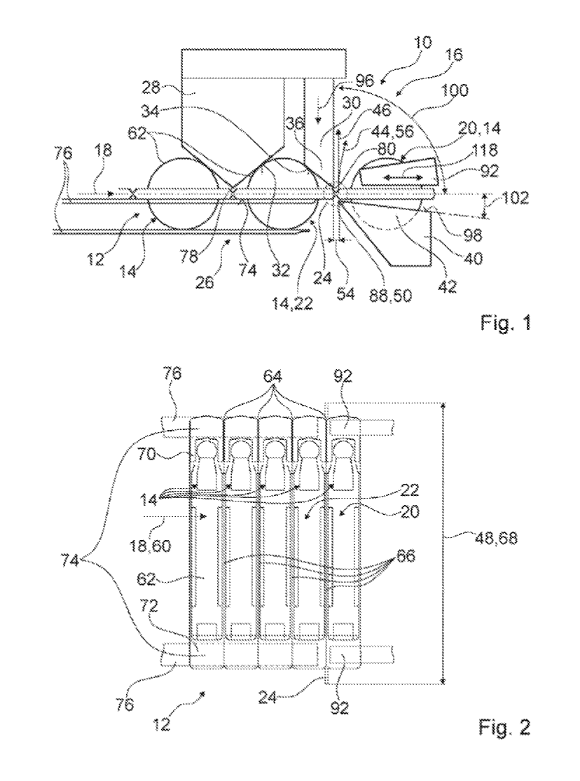

FIG. 1 shows a sketch of the principle of a device 10 for severing containers 14 that are connected in container groups 12, having a severing unit 16 that is provided for severing a container 20, which is foremost in a feed direction 18, of the container group 12 from a further container 22 of the container group 12 along a severing region 24, in a severing procedure transverse to the feed direction 18.

A positioning unit 26 is provided for form-fittingly positioning the container 22 of the container group 12 during the severing procedure, wherein the container 22 is arranged upstream of the severing region 24, as seen in the feed direction 18, and adjoins the severing region 24.

FIG. 2 shows a card-like container group 12, which is formed by six vial-like containers 14 that are arranged next to one another in a container group direction 60.

The container group 12 is made in a blow fill seal method, known to those skilled in the art, from a polypropylene material. The containers 14 have a container part 62 in which there is a filling material, for example a liquid medicament such as eye drops or similar. The containers 14 are connected to one another by connection webs 64. In each case centrally between the container parts 62 there are arranged weakened lines that form severing points 66. The severing points 66 extend in the direction of a principal extent 68 of the containers, which is perpendicular to the container group direction 60. In the principal direction 68 of extent, the containers 14 have a head part 70 at one end of the container part 62 and a foot part 72 at the opposite end. The containers 14 can be opened by breaking off the head part 70 to remove the filling material. End regions of the head part 70 and the foot part 72 take the form of flat guide surfaces 74. These guide surfaces 74 make it easier to position and guide the container group 12 in devices, using suitable transport and guidance devices. A plurality of such container groups 12 is supplied to the device 10, one after the other in the feed direction 18. As an alternative, it would also be possible for the container groups 12 to be discharged into the device 10, for example from a stack that is perpendicular to the feed direction 10 and to the principal extent 68, and then moved in the feed direction 18 for the purpose of severing the containers 20. As an alternative, the container groups 12 could also be pushed into the device 10 transversely, in the direction of the principal extent 68.

The positioning unit 26 has a first wedge 28, as seen in the feed direction 18, having a holding face 32, and a second wedge 30, as seen in the feed direction 18, having a holding face 34, wherein the holding faces 32, 34 are arranged opposite one another. In the example shown, the holding faces 32, 34 are of planar construction and position the container 22 by coming into contact with the container part 62 and thus pushing the container 22 into a target position and/or immobilizing it in this target position. During this, the container 22 is supported on its underside, which is remote from the holding faces 32, 34, in this example the respective underside of the guide surfaces 74, on a suitably constructed container support 76 that is also part of the positioning unit 26. In the example shown, the container support 76 is formed by dead plates, on which the containers 14, 20, 22 are pushed in the feed direction 18, and on which they are supported by means of their container parts 62 and guide surfaces 74. It is also conceivable for the containers 14 to be supported on the dead plate only by means of their container parts 62 or their guide surfaces 74.

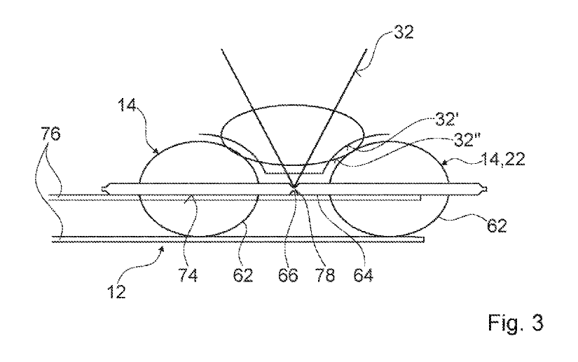

FIG. 3 shows possible alternative shapes of the holding face 32. If a support face, by means of which the holding face 32 comes into contact with the container part 62, is to be made larger, a construction according to the holding face 32′ is advantageous. The holding face 32′ is of concave construction and snugly follows a surface of the container part 62. In this way, the container part 62 can be treated with particular care. As an alternative, a holding face 32″ that is of convex construction may be advantageous if as small as possible an overall support face is to be achieved. The container part 62 may also have grooves in which a holding face 32″ of convex construction may advantageously engage. Those skilled in the art will determine the actual construction of the holding face 32 for the respective application case. The holding face 34 may be of a different construction to the examples that are shown here of the holding face 32. Instead of or in addition to the container part 62, the holding faces 32, 34 may also position the container 14 at the head part 70 or the foot part 72 or in a combination of container part 62 and/or head part 70 and/or foot part 72.

The wedges 28, 30 further have wedge edges 78, 80. The wedge edge 78 of the wedge 28 also forms part of the positioning unit 26 and comes into contact with the connection web 64 in the region of the severing point 66. Since the severing point 66 forms a depression into which the wedge edge 78 reaches, the container 22 is additionally immobilized. In particular for the purpose of processing particularly flexible container groups 12, it is possible additionally to provide a counter-piece that, from the side of the connection web 64 that is opposite the wedge edge 78, exerts thereon a counter-force to the force that is exerted by the wedge edge 78, and thus clamps the connection web 64 firmly.

The second wedge 30 further has a first severing blade 36 of the severing unit 16. The severing blade 36 is formed by the wedge edge 80 of the second wedge 30 and, at the start of the severing procedure, comes into contact with the connection web 64 between the container 22 and the container 20 that is to be severed, at the severing point 66 of this connection web 64. This region at the same time forms the severing region 24. Simultaneously, this contact also assists positioning of the containers 20, 22 in respect of the severing region 24 of the severing unit 16. In cases in which contact with the container part 62 is to be avoided, the positioning unit 26 may also position the container 20 exclusively with the aid of the contact of the wedge edges 78, 80 at the connection webs 64 or at the head part 70 or at the foot part 72.

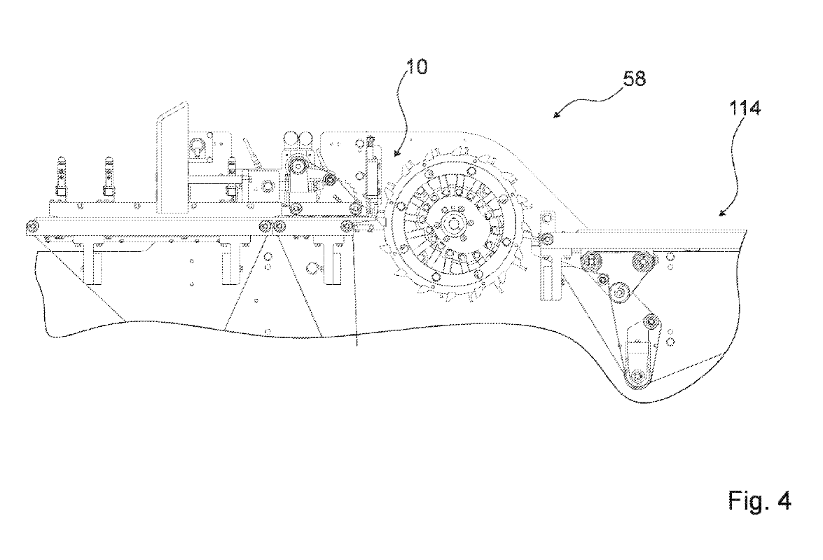

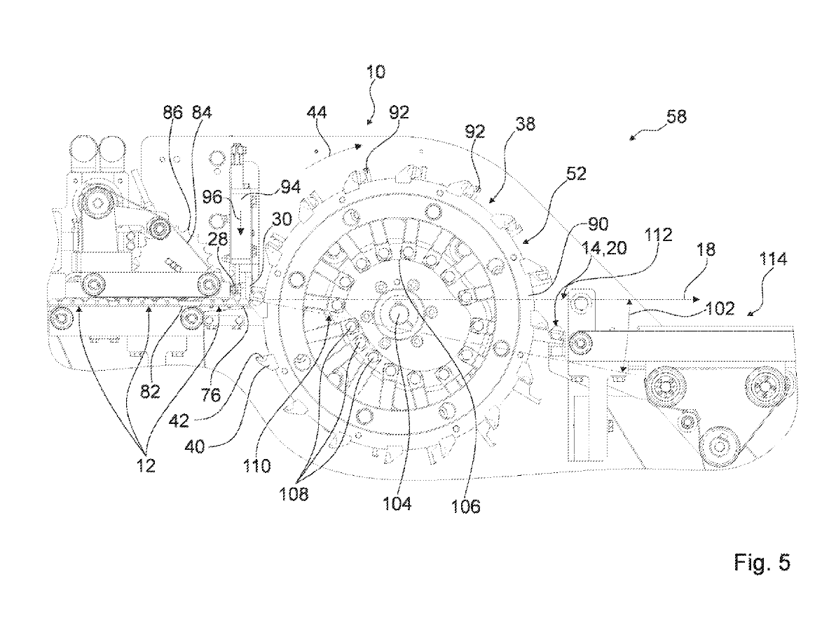

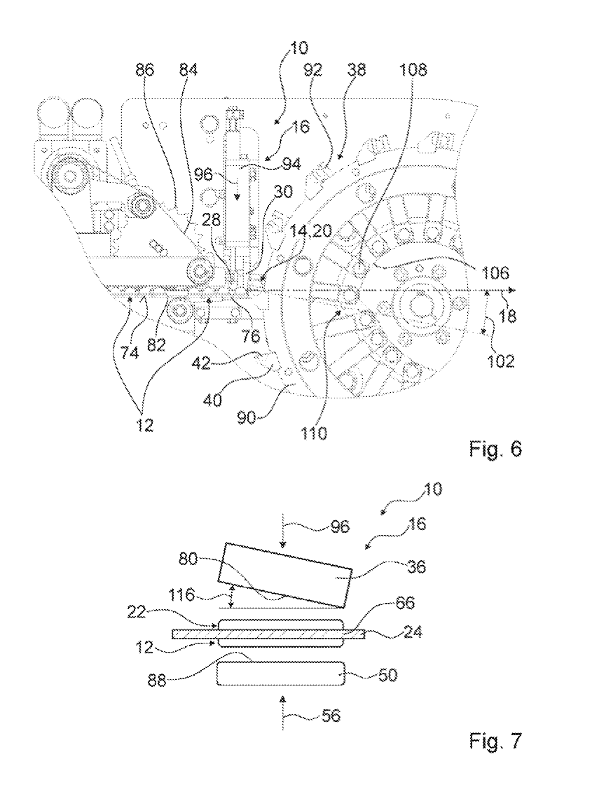

The device 10 further has a conveyor belt 82 (FIGS. 4-6) and an upper belt 84 that is arranged opposite on the side with the wedges 28, 30, and these act from both sides on the guide surfaces 74 of the container groups 12 and drive and guide the latter in the feed direction 18. A toothed counting wheel 86 engages in the part of the container group 12 that has the container parts 62 such that the container parts 62 engage in recesses in the toothing and thus turn the counting wheel 86 form-fittingly, in accordance with the current position of the container parts 62. The counting wheel 86 is connected to a control unit (which is not illustrated in more detail), which controls and regulates the movements of the device 10 by means of drives (which are not illustrated in more detail). The information from the counting wheel 86 serves to transport the container group 12 and the containers 14 correctly in the feed direction 18 so that the severing points 66 come to lie at the desired positions during the severing procedures and, if containers 14 are not positioned correctly, trigger an alarm and/or a machine stoppage.

An onward transport unit 38 has a plurality of holders 40, which are arranged in a cycle 52. The cycle 52 is formed by a transport wheel 90 on which the holders 40 are arranged. The holders 40 form receiving regions 42 for receiving the containers 20 that are each severed in a severing procedure. Mounted on the transport wheel 90, on sides of the holders 40 that are opposite the receiving regions 42, are counter-holders 92 that are displaceable in a closing movement 118 such that they can be pushed over the receiving regions 42 for the purpose of securing containers 14 that have been inserted in the receiving regions 42. The holders 40 for this purpose have further severing blades 50 of the severing unit 16. The severing unit 16 is thus formed by the severing blades 36, 50 and the positioning unit 26. The severing blades 50 are formed by edges 88 of the holders 40. The onward transport unit 38 is provided for the purpose of transporting severed containers 14 onward in an onward transport movement 44 that, directly downstream of the severing procedure, has a principal motion component 46 perpendicular to the feed direction 18 and transverse to a principal extent 48 of the severing region 24.

The onward transport movement 44 forms a shearing movement 56 during the severing procedure. The severing procedure is performed by the severing blades 36, 50, which are moved past one another with the shearing movement 56 at a minimum severing clearance 54 at 0.1-0.3 mm.

FIG. 7 shows the movement in the closing direction 96 of the first, and the shearing movement 56 of one of the further, shearing blades 36, 50, in a plan view perpendicular to the feed direction 18. The wedge edge that forms the first shearing blade 36 is advantageously, as can be seen in this figure, inclined in relation to the severing region 24 by an angle 116 such that when the two severing blades 36, 50 are moved past one another by the shearing movement 56 the severing point 66 between the container 20, which is not illustrated in this figure, and the container 22 is severed in a punctiform shearing.

With reference to FIGS. 4-6, which show a supply device 58 having the device 10 for severing containers 14 that are connected in container groups 12, functioning of the device 10 will be explained in more detail.

The upper belt 84 and the conveyor belt 82 act from both sides on the guide surfaces 74 of the container groups 12 and transport them in the feed direction 18, in the direction of the severing region 24 of the severing unit 16. The counting wheel 86 monitors this feeding. The control unit (which is not illustrated) controls and regulates the movements of the supply device 58 having the device 10. The wedges 28, 30 are mounted on a linear unit 94 that drives the wedges 28, 30 together in a stroke movement, in a closing direction 96 that is perpendicular to the feed direction 18 and to the principal extent 48 of the severing region 24. The closing direction 96 forms an angle 100 of 90° with the feed direction 18. Once the container group 12 has been moved far enough in the feed direction 18 for the severing point 66 between the container 22 and the container 20 that is to be severed to be located in the severing region 24 of the severing unit 16, the linear unit 94 lowers the wedges 28, 30 in the direction of the container group 12 until the wedges 28, 30 come into contact with the container 22 and position it. The wedge 28 is mounted, such that it is resilient in the closing direction 96, on the linear unit 94 by a spring element (which is not illustrated in more detail). The second wedge 30 is set back in the closing direction 96 by approximately 1 mm in relation to the first wedge 28 in the relaxed condition. When the wedges 28, 30 are lowered in the closing direction 96 onto the container 22, first the wedge edge 78 and the holding face 32 of the first wedge 28 come into contact with the container 22. The linear unit 94 moves the wedge 30 further in the direction of the container 22, while the wedge 28 begins to undergo spring compression and so remains in its position. Consequently, the holding face 34 of the second wedge 30 now also comes into contact with the container part 62 of the container 22 and urges the container 22 in the direction of the first wedge 28. The container 22 is centered and positioned between the holding faces 32, 34. As a result of a spring force of the spring element, the first wedge 28 additionally firmly clamps the container 22 at its severing point 66, by means of its wedge edge 78, without severing the severing point 66 as a result of excessive force. The wedge edge 80 of the second wedge 30 is now located in the severing region 24, in the position for severing the containers 20, 22.

In the illustration of FIGS. 4-6, the transport wheel 90 rotates clockwise with the onward transport movement 44, which in the severing region 24 is approximately perpendicular to the feed direction 18. In the exemplary embodiment, the onward transport movement 44 is continuous, but a discontinuous onward transport movement 44 is also conceivable. In particular, the onward transport movement 44 may be controlled in dependence on a downstream machine 114. The counter-holders 92 of the holders 40 are retracted in the direction of a center of rotation of the transport wheel 90 before the holders 40 pass the severing region 24, with the result that the receiving regions 42 of the holders 40 have openings for receiving the containers 20 that are to be severed. The holder 40 that is closest to the severing region 24, in the direction opposed to the onward transport movement 44, moves past the severing point 24. A respective upper side 98 of the holders 40, in which the openings of the receiving regions 42 are made, is inclined in relation to a radius of the transport wheel 90 such that the upper surface 98 forms an angle 102 of 10° with the feed direction 18, starting from the edge 88. The holder 40 comes into contact with the container 20 and takes up the side of the container part 62 that faces the receiving region 42, while the guide surfaces 74 of the container 20 come to lie on the upper side 98. Because of the inclination by the angle 102, the container 20 is urged from the severing point 24 in the direction of a center of rotation 104 of the transport wheel 90. The counter-holder 92 that is opposite the holder 40 is now displaced away from the center of rotation 104 over the receiving region 42, with the result that the counter-holder 92 secures the container 20 at the guide surfaces 74 of the container 20 (see FIG. 2) in the receiving region 42 to prevent it from falling out. The container 20 that is thus secured is now severed from the container 22. The edge 88 of the holder 40 forms one of the further severing blades 50 and moves past the first severing blade 36 with the severing clearance 54, and now severs the container 20 in the severing region 24. A control cam 106, with which control followers 108 of the counter-holders 92 engage, has a suitable deflected portion 110 at the corresponding position in the cycle 52, in order to trigger the counter-holder 92 such that, when it passes the severing region 24, it secures the container 20. After half a rotation of the transport wheel 90, the holder 40 reaches a discharge region 112. Since the transport wheel 90 has by now rotated through 180°, the container 20 is now supported on the counter-holder 92. The counter-holder 92 is moved somewhat away from the holder 40 by the control cam 106 and is extended far enough from the center of rotation 104 for the container 20 to be released by the holder 40 and to be discharged by the counter-holder 92 to the downstream machine 114, for example a packaging machine. This process is repeated continuously with each holder 40 in the cycle 52 of the transport wheel 90, and with each severed container 20. During this, the transport wheel 90 can advantageously rotate at a constant speed or be controlled in dependence on a requirement of the downstream machine 114.

1. A device for severing containers that are connected in container groups, comprising:
a severing unit that is configured to sever at least one container located at a foremost position in a container group in a feed direction from at least one further container in the container group located upstream of the at least one container via a severing procedure that acts along a severing region of the severing unit, in a direction transverse to the feed direction; and
a positioning unit that is configured to form-fittingly position the at least one further container along the feed direction during the severing procedure.

2. The device as claimed in claim 1, wherein the positioning unit is further configured to form-fittingly position the at least one further container of the container group in a direction opposite to the feed direction during the severing procedure.

3. The device as claimed in claim 1, wherein the positioning unit includes at least a first wedge arranged along the feed direction, and a second wedge arranged the feed direction, the first wedge and the second wedge each having respective faces that are oriented at least partly opposite each other.

4. The device as claimed in claim 3, wherein the second wedge has a first severing blade of the severing unit.

5. The device as claimed in claim 1, further comprising:
an onward transport unit including at least one holder that defines a receiving region configured to receive the at least one container severed in a severing procedure.

6. The device as claimed in claim 5, wherein the onward transport unit is further configured to transport a plurality of containers in an onward transport movement that, at least directly downstream of the severing procedure, has a principal motion component oriented perpendicular to the feed direction and transverse to a principal extent of the severing region.

7. The device at least as claimed in claim 5, further comprising:
at least one holder that has a further severing blade of the severing unit.

8. The device at least as claimed in claim 5, wherein the onward transport unit has a plurality of holders arranged in a cycle.

9. The device as claimed in claim 1, further comprising:
two severing blades that are configured to move past each other with a severing clearance in a shearing movement to enable the severing procedure.

10. A supply device for containers, comprising:
a device for severing containers that are connected in container groups, the device including:
a severing unit that is configured to sever at least one container located at a foremost position in a container group in a feed direction from at least one further container in the container group located upstream of the at least one container via a severing procedure that acts along a severing region of the severing unit in a direction transverse to the feed direction; and
a positioning unit that is configured to form-fittingly position the at least one further container during the severing procedure.

11. A method for severing at least one container from containers that are connected in a container group, the method comprising:
operating a severing unit to perform a severing procedure along a severing region of a severing unit to sever at least one container in the container group from at least one further container the container group, the severing procedure acting in a direction transverse to a feed direction for feeding the container group through the severing unit and
during the severing procedure, operating a positioning unit to form-fittingly position the at least one further container along the feed direction.
